(19) United States
(12) Patent Application Publication
(10) Pub. No.: US 2025/0279092 A1
(43) Pub. Date: Sep. 4, 2025

(54) SPEECH ENCODERS WITH THINK TOKENS

(71) Applicant: Google LLC, Mountain View, CA (US)

(72) Inventors: Tien-Ju Yang, Mountain View, CA (US); Andrew Rosenberg, Brooklyn, NY (US); Bhuvana Ramabhadran, Mt. Kisco, NY (US); Pedro J. Moreno Mengibar, Jersey City, NJ (US)

(73) Assignee: Google LLC, Mountain View, CA (US)

(21) Appl. No.: 19/050,734

(22) Filed: Feb. 11, 2025

Related U.S. Application Data
(60) Provisional application No. 63/559,811, filed on Feb. 29, 2024.

(51) Int. Cl. G10L 15/16; G06F 40/58; G10L 15/06; G10L 15/30

(52) U.S. Cl. CPC G10L 15/16; G06F 40/58; G10L 15/063; G10L 15/30

(57) ABSTRACT

A method includes receiving a sequence of input tokens and inserting a sequence of special think tokens into the sequence of input tokens. The inserted special tink tokens are interleaved with the sequence of input tokens. The method also includes processing, using an encoder, the sequence of input tokens interleaved with the sequence of special think tokens to generate a sequence of encoder features. The method also includes processing the sequence of encoder features to generate an output result.

### CROSS-REFERENCE TO RELATED APPLICATIONS

This U.S. patent application claims priority under 35 U.S.C. § 119 (e) to U.S. Provisional Application 63/559,811, filed on Feb. 29, 2024. The disclosure of this prior application is considered part of the disclosure of this application and is hereby incorporated by reference in its entirety.

### TECHNICAL FIELD

This disclosure relates to speech encoders with think tokens.

### BACKGROUND

End-to-end automatic speech recognition (ASR) models have seen revolutionary quality gains with the recent development of large-scale universal speech models (USM). Encoders play a pivotal role in ASR models, serving as the gateway for feature extraction and representation. Notably, increasing per-token computation of these extracted features within the encoder is known to enhance feature representation quality. While conventional techniques primarily aim to increase the size of the encoder to increase per token computation, these techniques dramatically increase the parameter count of the encoder model, and thus, especially pose challenges of large-scale USMs which are already at massive scale with parameter counts capable of exceeding several billion parameters.

### SUMMARY

One aspect of the disclosure provides a computer-implemented method that when executed on data processing hardware causes the data processing hardware to perform operations that include receiving a sequence of input tokens and inserting a sequence of special think tokens into the sequence of input tokens, wherein the inserted special think tokens are interleaved with the sequence of input tokens. The operations also include processing, using an encoder, the sequence of input tokens interleaved with the sequence of special think tokens to generate a sequence of encoder features and processing the sequence of encoder features to generate an output result.

Implementations of the disclosure may include one or more of the following optional features. In some implementations, inserting the sequence of special tokens includes, for each corresponding input token in the sequence of input tokens, prepending a fixed number of the special think tokens to the corresponding input token. In other implementations, inserting the sequence of special tokens includes, for each corresponding input token in the sequence of input tokens, prepending a fixed number of the special think tokens to the corresponding input token.

In some examples, the sequence of input tokens comprises a sequence of speech tokens characterizing a spoken utterance and the encoder includes a speech encoder. Here, the output result may include a transcription of the spoken utterance or a synthetic speech translation of the spoken utterance.

The special think tokens may include handcrafted think tokens. Alternatively, the sequence of special think tokens include duplications of the sequence of input tokens, wherein inserting the sequence of special tokens includes, for each corresponding input token in the sequence of input tokens: duplicating the corresponding input token; and appending or prepending one or more duplications of the corresponding input token to the corresponding input token. Optionally, the special think tokens may include learnable parameters.

In some implementations, a number of the encoder features in the sequence of encoder features is equal to a sum of a number of the input tokens in the sequence of input tokens and a number of the special think tokens in the sequence of special think tokens. In these implementations, processing the sequence of encoder features to generate the output result includes down-sampling the sequence of encoder features to obtain a down-sampled encoder feature sequence and processing, using a decoder, the down-sampled encoder feature sequence to generate the output result. Here, a number of the encoder features in the down-sampled encoder feature sequence is equal to the number of the input tokens in the sequence of input tokens.

In some examples, processing the sequence of encoder features to generate the output result includes processing, using a decoder, the sequence of encoder features to generate the output result. Here, a number of the encoder features in the sequence of encoder features may be greater than a number of the input tokens in the sequence of input tokens.

A model implementing the encoder may be trained by a training process that includes: obtaining a set of set of training input token sequences, each training input token sequence including a corresponding sequence of training input tokens; for each training input token sequence: inserting a corresponding sequence of training think tokens into the training input token sequence such that corresponding sequence of training think tokens are interleaved with the corresponding sequence of training input tokens; and processing, using the encoder, the training input token sequence interleaved with the corresponding sequence of training think tokens to generate a sequence of training encoder features; and training the model based on the sequence of training encoder features generated for each training input token sequence. A ratio of the corresponding sequence of training think tokens inserted into each training input token sequence gradually increases during the training process. The model may include a recurrent neural network-transducer (RNN-T) architecture including the encoder, a prediction network, and a joint network.

Another aspect of the disclosure provides a system that includes data processing hardware and memory hardware storing instructions that when executed on the data processing hardware causes the data processing hardware to perform operations that include receiving a sequence of input tokens and inserting a sequence of special think tokens into the sequence of input tokens, wherein the inserted special think tokens are interleaved with the sequence of input tokens. The operations also include processing, using an encoder, the sequence of input tokens interleaved with the sequence of special think tokens to generate a sequence of encoder features and processing the sequence of encoder features to generate an output result.

This aspect of the disclosure may include one or more of the following optional features. In some implementations, inserting the sequence of special tokens includes, for each corresponding input token in the sequence of input tokens, prepending a fixed number of the special think tokens to the corresponding input token. In other implementations, inserting the sequence of special tokens includes, for each corresponding input token in the sequence of input tokens, prepending a fixed number of the special think tokens to the corresponding input token.

In some examples, the sequence of input tokens comprises a sequence of speech tokens characterizing a spoken utterance and the encoder includes a speech encoder Here, the output result may include a transcription of the spoken utterance or a synthetic speech translation of the spoken utterance.

The special think tokens may include handcrafted think tokens. Alternatively, the sequence of special think tokens include duplications of the sequence of input tokens, wherein inserting the sequence of special tokens includes, for each corresponding input token in the sequence of input tokens: duplicating the corresponding input token; and appending or prepending one or more duplications of the corresponding input token to the corresponding input token. Optionally, the special think tokens may include learnable parameters.

In some implementations, a number of the encoder features in the sequence of encoder features is equal to a sum of a number of the input tokens in the sequence of input tokens and a number of the special think tokens in the sequence of special think tokens. In these implementations, processing the sequence of encoder features to generate the output result includes down-sampling the sequence of encoder features to obtain a down-sampled encoder feature sequence and processing, using a decoder, the down-sampled encoder feature sequence to generate the output result. Here, a number of the encoder features in the down-sampled encoder feature sequence is equal to the number of the input tokens in the sequence of input tokens.

In some examples, processing the sequence of encoder features to generate the output result includes processing, using a decoder, the sequence of encoder features to generate the output result. Here, a number of the encoder features in the sequence of encoder features may be greater than a number of the input tokens in the sequence of input tokens.

A model implementing the encoder may be trained by a training process that includes: obtaining a set of set of training input token sequences, each training input token sequence including a corresponding sequence of training input tokens, for each training input token sequence: inserting a corresponding sequence of training think tokens into the training input token sequence such that corresponding sequence of training think tokens are interleaved with the corresponding sequence of training input tokens; and processing, using the encoder, the training input token sequence interleaved with the corresponding sequence of training think tokens to generate a sequence of training encoder features; and training the model based on the sequence of training encoder features generated for each training input token sequence. A ratio of the corresponding sequence of training think tokens inserted into each training input token sequence gradually increases during the training process. The model may include a recurrent neural network-transducer (RNN-T) architecture including the encoder, a prediction network, and a joint network.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for performing speech recognition.

FIG. 2 is a schematic view of a Recurrent Neural Network-Transducer (RNN-T) model architecture.

FIG. 3 is an example training process for training an audio encoder of a speech recognition model to increase a per speech token computation of the audio encoder.

FIG. 4 is a schematic view of a speech recognition model utilizing a contemplative mechanism to insert special think tokens into a sequence of speech tokens to increase per speech token computation by an audio encoder.

FIG. 5 is an example plot depicting speech recognition performance of models of varying size with and without utilizing a contemplative mechanism.

FIG. 6 is a flowchart of an exemplary arrangement of operations for a method of increasing computation per speech token within an encoder while maintaining an original parameter count of the encoder.

FIG. 7 is a schematic view of an example computing device that may be used to implement the systems and methods described herein.

Like reference symbols in the various drawings indicate like elements.

### DETAILED DESCRIPTION

End-to-end automatic speech recognition (ASR) models have seen revolutionary quality gains with the recent development of large-scale universal speech models (USM). Encoders play a pivotal role in ASR models, serving as the gateway for feature extraction and representation. When the encoder is an audio encoder, the extracted features may be referred to as ‘speech tokens” each corresponding to a respective audio feature (e.g., fixed-length audio frame) in a sequence of extracted audio features characterizing a spoken utterance.

Notably, increasing per-token computation of these extracted features within the encoder is known to enhance feature representation quality. While conventional techniques primarily aim to increase the size of the encoder to increase per token computation, these techniques dramatically increase the parameter count of the encoder model, and thus, especially pose challenges of large-scale USMs which are already at massive scale with parameter counts capable of exceeding several billion parameters. That is, further increasing the parameter count of large-scale USMs introduces complexities beyond mere computational demand such as hindering storage, data transmission, and efficient loading of data into virtual random access memory (VRAM) for execution by underlying data processing hardware, e.g., graphical processing units (GPUs) and/or tensor processing units (TPUs).

Implementations herein are directed toward a strategic technique of increasing computation per speech token within an encoder while maintaining an original parameter count of the encoder. Specifically, implementations are directed toward receiving a sequence of input tokens to be encoded by the encoder and inserting a sequence of special think tokens into the sequence of input tokens such that the inserted special think tokens are interleaved within the sequence of input tokens, and processing, using the encoder, the sequence of input tokens interleaved with the sequence of special think tokens to generate a sequence of encoder features. Thereafter, further processing is performed on the sequence of encoder features to generate an output result. The sequence of special tokens may be inserted by either appending or prepending a fixed number of the special think tokens to each corresponding input token. As a result, a number of the encoder features in the sequence of encoder features is equal to a sum of a number of the input tokens in the sequence of input tokens and an umber of the special tokens in the sequence of special tokens. Since the number of encoder features is greater than the number of the input tokens in the sequence of input tokens, the processing of the sequence of input features to generate the output result may include down-sampling the sequence of the encoder features to obtain a down-sampled encoder feature sequence having a same number of encoder features as the number of the input tokens in the sequence of input tokens and processing, using a decoder, the down-sampled encoder feature sequence to generate the output result.

As will become apparent, the interleaving of the special think tokens within the sequence of input tokens increases per token computation by the encoder to unlock performance gains within neural networks without incurring the prohibitive costs associated within increasing the encoder model size via scaling techniques. For instance, in speech recognition tasks where the encoder includes an audio encoder and the output result is a transcription of an utterance characterized by the sequence of input tokens, the interleaving of the special think tokens can yield word error rate (WER) reductions comparable to those of models twice their size. As such, by circumventing the conventional size-performance tradeoff, the techniques of increasing computation per input token within an encoder disclosed herein aim to advance the capabilities of neural network models while ensuring their practicality and sustainability. The techniques of interleaving the special think tokens within the sequence of input tokens can be applied during both training and inference of the underlying model to ensure model robustness.

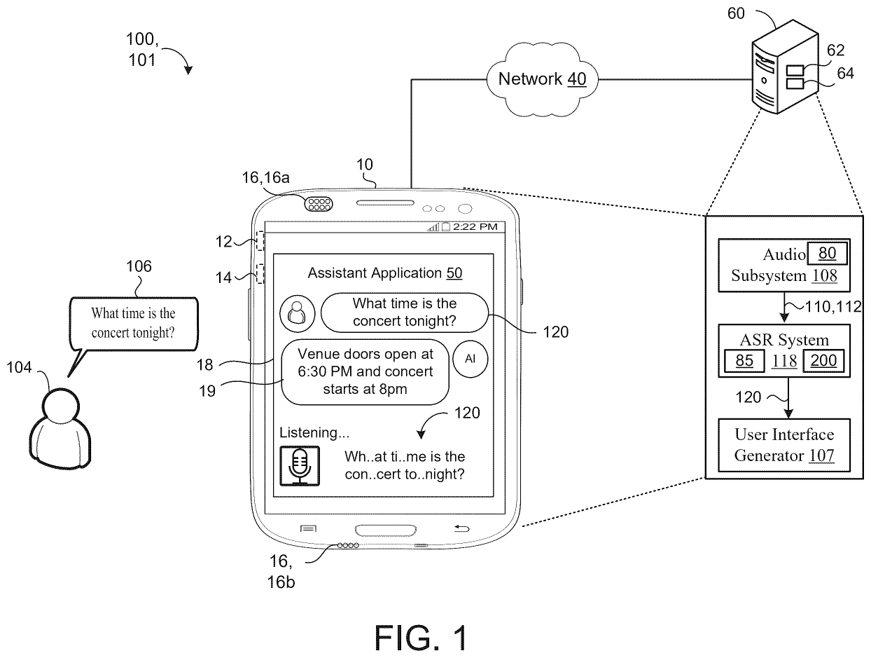

FIG. 1 is an example of a system 100 operating in a speech environment 101. In the speech environment 101, a user's 104 manner of interacting with a computing device, such as a user device 10, may be through voice input. The user device 10 (also referred to generally as a device 10) is configured to capture sounds (e.g., streaming audio data) from one or more users 104 within the speech environment 100. Here, the streaming audio data may refer to a spoken utterance 106 by the user 104 that functions as an audible query, a command for the device 10, or an audible communication captured by the device 10. Speech-enabled systems of the device 10 may field the query or the command by answering the query and/or causing the command to be performed/fulfilled by one or more downstream applications.

The user device 10 may correspond to any computing device associated with a user 104 and capable of receiving audio data. Some examples of user devices 10 include, but are not limited to, mobile devices (e.g., mobile phones, tablets, laptops, etc.), computers, wearable devices (e.g., smart watches), smart appliances, internet of things (IoT) devices, vehicle infotainment systems, smart displays, smart speakers, etc. The user device 10 includes data processing hardware 12 and memory hardware 14 in communication with the data processing hardware 12 and storing instructions, that when executed by the data processing hardware 12, causes the data processing hardware 12 to perform one or more operations. The user device 10 further includes an audio system 16 with an audio capture device (e.g., microphone) 16, 16a for capturing and converting spoken utterances 106 within the speech environment 100 into electrical signals and a speech output device (e.g., a speaker) 16, 16b for communicating an audible audio signal (e.g., as output audio data from the device 10). While the user device 10 implements a single audio capture device 16a in the example shown, the user device 10 may implement an array of audio capture devices 16a without departing from the scope of the present disclosure, whereby one or more capture devices 16a in the array may not physically reside on the user device 10, but be in communication with the audio system 16.

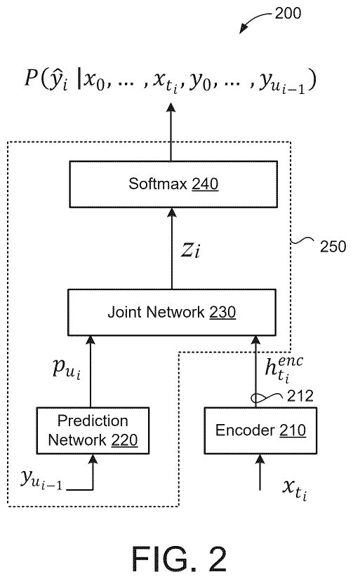

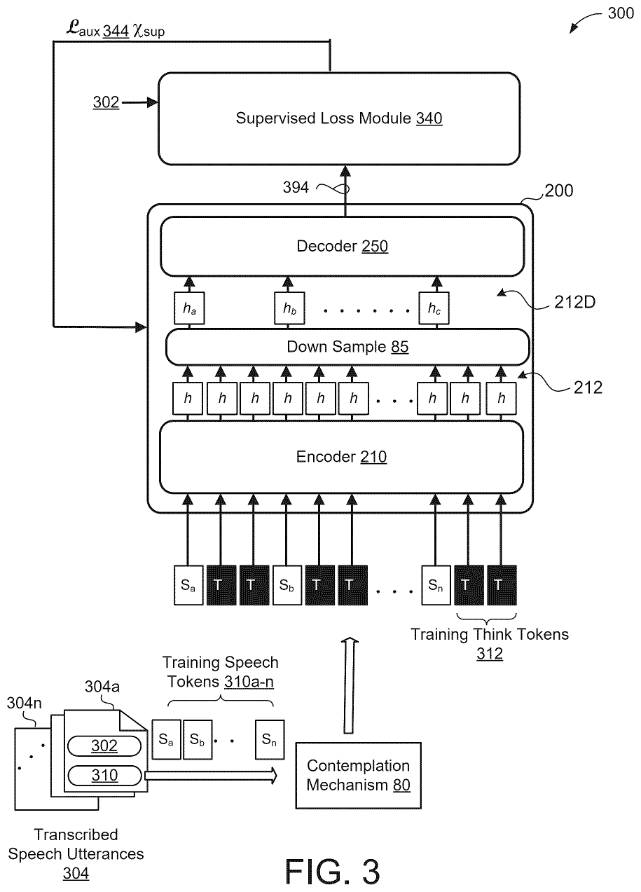

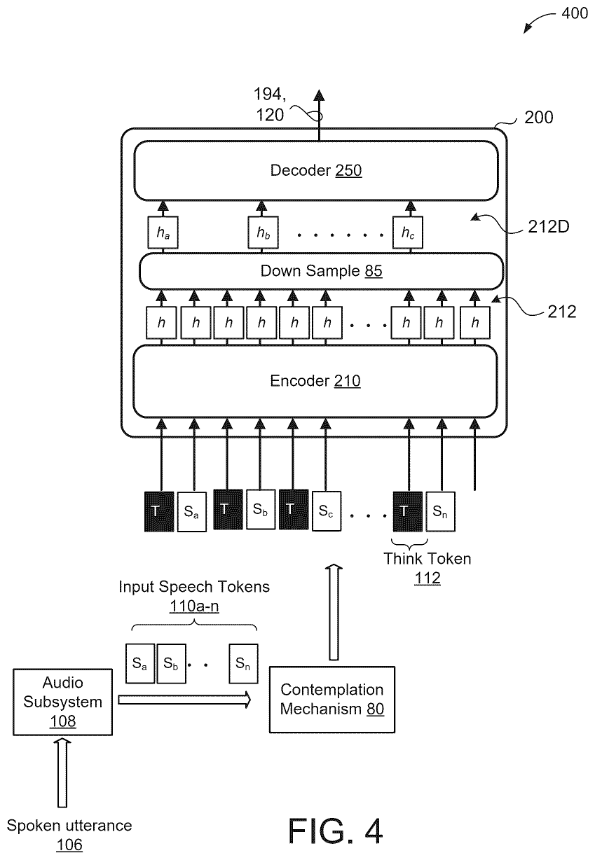

In the speech environment 100, an automated speech recognition (ASR) system 118 includes an ASR model 200 (such as an ASR model having a recurrent neural network-transducer (RNN-T model architecture or other transducer model/multi-pass model) that resides on the user device 10 of the user 104 and/or on a remote computing device 60 (e.g., one or more remote servers of a distributed system executing in a cloud-computing environment) in communication with the user device 10 via a network 40. The remote computing device 60 is equipped with data processing hardware 62 and memory hardware 64. The user device 10 and/or the remote computing device 60 also includes an audio subsystem 108 configured to receive the utterance 106 spoken by the user 104 and captured by the audio capture device 16a, and convert the utterance 106 into a corresponding digital format associated with input speech tokens (e.g., acoustic frames) 110 capable of being processed by the ASR system 118. In the example shown, the user speaks a respective utterance 106 and the audio subsystem 108 converts the utterance 106 into corresponding speech tokens (e.g., acoustic frames) 110 for input to the ASR system 118. Described in further detail below with reference to FIGS. 3 and 4, the audio subsystem 108 further implements a contemplative mechanism 80 configured to insert a sequence of special think tokens 112 into the sequence of input speech tokens 110 such that the inserted special think tokens 112 are interleaved with the sequence of input speech tokens 110 prior to processing by an encoder 210 (FIGS. 2-4) of the model 200 in order to increase per token computation within the encoder 210. Accordingly, the model 200 receives, as input, the sequence of input speech tokens 110 corresponding to the utterance 106 interleaved with the sequence of special think tokens, and generates/predicts, as output, a corresponding transcription 120 (e.g., speech recognition result/hypothesis) of the utterance 106. Notably, while the example of FIG. 1 depicts a streaming speech recognition example where the spoken utterance 106 is captured in streaming audio and processed in real-time, the ASR system 118 may similarly perform non-streaming speech recognition on the utterance after the user 104 finishes speaking the utterance 106 without departing from the scope of the present disclosure. Notably, in non-streaming applications, the utterance 106 may pertain to a pre-recorded utterance 106 input to the audio subsystem 108 as an audio file.

The user device 10 and/or the remote computing device 60 also executes a user interface generator 107 configured to present a representation of the transcription 120 of the utterance 106 to the user 104 of the user device 10. As described in greater detail below, the user interface generator 107 may display the speech recognition results 120 in a streaming fashion. In some configurations, the transcription 120 output from the ASR system 118 is processed, e.g., by a natural language understanding (NLU) module executing on the user device 10 or the remote computing device 60, to execute a user command/query specified by the utterance 106. Additionally or alternatively, a text-to-speech system (not shown) (e.g., executing on any combination of the user device 10 or the remote computing device 60) may convert the transcription into synthesized speech for audible output by the user device 10 and/or another device.

In the example shown, the user 104 interacts with a program or application 50 (e.g., the digital assistant application 50) of the user device 10 that uses the ASR system 118. For instance, FIG. 1 depicts the user 104 communicating with the digital assistant application 50 and the digital assistant application 50 displaying a digital assistant interface 18 on a screen of the user device 10 to depict a conversation between the user 104 and the digital assistant application 50. In this example, the user 104 asks the digital assistant application 50, “What time is the concert tonight?” This question from the user 104 is a spoken utterance 106 captured by the audio capture device 16a and processed by the audio systems 16 of the user device 10. In this example, the audio subsystem 108 receives the spoken utterance 106 and converts it into acoustic frames 110 for input to the ASR system 118.

Referring to FIG. 2, an example frame alignment-based transducer model 200 includes a Recurrent Neural Network-Transducer (RNN-T) model architecture which adheres to latency constrains associated with interactive applications. The use of the RNN-T model architecture is exemplary, and the frame alignment-based transducer model 200 may include other architectures such as transformer-transducer and conformer-transducer model architectures among others. The RNN-T model 200 provides a small computational footprint and utilizes less memory requirements than conventional ASR architectures, making the RNN-T model architecture suitable for performing speech recognition entirely on the user device 102 (e.g., no communication with a remote server is required). The RNN-T model 200 includes an encoder network (i.e., audio encoder) 210, a prediction network 220, and a joint network 230. The audio encoder 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the audio encoder 210 reads a sequence of d-dimensional feature vectors (e.g., speech tokens 110 (FIG. 1)) x=(x₁, x₂, . . . , x_{T}), where xₜ∈ [symbol] , interleaved with a sequence of a sequence of special tokens 112 (i.e., by the contemplation mechanism 80 (FIG. 1) and produces at each output step a higher-order feature representation. This higher-order feature representation is denoted as h₁^{enc}, . . . , h_{T}^{enc} and may be interchangeably referred to as an ‘encoder feature’ 212.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. While not shown, the sequence of encoder features 212 output by the encoder may be down-sampled prior to processing by the joint network 230 so that a number of the encoder-features after down-sampling is equal to a number of the speech tokens 110 in the sequence of input speech tokens 110 The prediction network 220 may be replaced by an embedding look-up table to improve latency by outputting looked-up sparse embeddings in lieu of processing dense representations.

The joint network then predicts P(yᵢ|xₜ_{ᵢ}, y₀, . . . , yᵤ_{ᵢ₋₁}), which is a distribution over the next output symbol. Stated differently, the joint network 230 generates, at each output step (e.g., time step), a probability distribution over possible speech recognition hypotheses Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics but also on the sequence of labels output so far. The RNN-T model 200 does assume an output symbol is independent of future acoustic frames 110, which allows the RNN-T model to be employed in a streaming fashion.

In some examples, the encoder network (i.e., audio encoder) 210 of the RNN-T model 200 includes a stack of self-attention layers/blocks, such as conformer layers/blocks. In some examples, the number of self-attention layers/blocks in the audio encoder is equal to 24. For instance, the audio encoder 210 may include 150 million parameters having 24 conformer layers with 512 hidden dimensions, 300 million parameters having 24 conformer layers with 768 hidden dimensions, or 600 million parameters having 24 conformer layers with 1,024 hidden dimensions. In some examples, the relative attention in each self-attention layer is equal to 16 attention heads. Here, each conformer block includes a series of multi-headed self attention, depth wise convolution and feed-forward layers. The stack of self-attention layers/blocks may include transformer layers/blocks in other examples. The prediction network 220 may have two 2,048-dimensional LSTM layers, each of which is also followed by 640-dimensional projection layer. Alternatively, the prediction network 220 may include a stack of transformer or conformer blocks, or an embedding look-up table in lieu of LSTM layers. Finally, the joint network 230 may also have 640 hidden units. The Softmax layer 240 may be composed of a unified word piece or grapheme set that is generated using all unique word pieces or graphemes in a plurality of training data sets. The prediction network 220, the joint network 230, and the Softmax layer 240 may collectively form an RNN-T decoder 250 of the RNN-T model 200.

FIG. 3 illustrates an example training process 300 for training the audio encoder 210 of the ASR model 200 (FIG. 2). Notably, the audio encoder 210 may be initially pre-trained and the training process 300 trains/fine-tunes the audio encoder 210 from the pre-trained checkpoint. For instance, the audio encoder 210 may be pre-trained on any combination of text-only utterances not paired any spoken representations of the utterances, un-transcribed speech utterances not paired with any corresponding transcriptions of the utterances, and transcribed speech utterances each including a speech representation of an utterance paired with a corresponding transcription of the utterance. An example pre-training process for pre-training the audio encoder 210 is disclosed in commonly assigned U.S. patent application Ser. No. 18/585,168, filed on Feb. 23, 2024, the contents of which are incorporated by reference its entirety.

The training process 300 trains the audio encoder 210 based on supervised losses (Lₐᵤₓ) 344 derived from a set of transcribed speech utterances (Xₛᵤₚ) 304, 304a-n. Each transcribed speech utterance 304 includes a corresponding transcription 302 paired with a corresponding training input token sequence 310 characterizing a speech representation of the corresponding transcribed speech utterance 304. Each corresponding training input token sequence 310 includes a corresponding sequence of training input tokens 310, 310a-n. Here, the training input tokens 310 may include training input speech tokens 310 each representing a respective acoustic frame.

For each training input token sequence 310 of each transcribed speech utterance 304, the contemplation mechanism 80 inserts a corresponding sequence of training think tokens 312 into the training input token sequence 310 such that the corresponding sequence of training think tokens 312 are interleaved with the corresponding sequence of training input tokens 310a-n. For each corresponding training input token 310, the contemplation mechanism 80 may insert the corresponding sequence of training think tokens 312 by appending or prepending a fixed number of the training think tokens 312 to the corresponding training input token 310. In the example shown, the contemplation mechanism 80 appends two think tokens 312 to each training input token 310. Notably, the contemplation mechanism 80 may append only one think token or more than three think tokens 312 to each training input token 310, or instead, the contemplation mechanism 80 may prepend one, two, or more than two think tokens 312 to each training input token 310 without departing from the scope of the present disclosure.

In some implementations, the training process 300 gradually increases a ratio of the corresponding sequence of training think tokens inserted into each training input token sequence 310. Here, an annealing technique gradually increases the ratio of the corresponding sequence of think tokens 312 according to an annealing schedule when the training process 300 is fine-tuning the audio encoder 210 from the pre-trained checkpoint. The annealing schedule may lead to faster convergence and reduced error rates of the model 200 during the training process 300 compared to using a constant think token ratio where the fixed number of think tokens appended or prepended to each training input token 310 remains static during the entire training process 300

Next, the training process 300 processes, using the audio encoder 210, the training input token sequence 310 interleaved with the corresponding sequence of training think tokens 312 to generate a sequence of training encoder features h 212. The audio encoder 210 may generate a training encoder feature 210 from a respective speech token 310 or think token 312 at each corresponding time step. Notably, a number of the training encoder features 210 is equal to a sum of a number of the training input tokens 310a-n in the corresponding sequence of training input tokens 310 and a number of the think tokens 312 in the sequence of special tokens 312. Thus, as the number of training encoder features 210 is greater than the number of training input tokens in the corresponding sequence of training input tokens 310, a down sample mechanism 85 may down-sample the sequence of training encoder features h 212 output by the encoder 210 to obtain a down-sampled encoder feature sequence 212D. Here, the down-sampled encoder feature sequence 212D includes a number of encoder features 212 that is equal to the number of training input tokens 310 in the sequence of training input tokens 310. Thereafter, the decoder 250 processes the down-sampled encoder feature sequence 212D to generate an output result 394. Specifically, the decoder 250 receives, as input, each encoder feature 212 from the down-sampled encoder feature sequence 212D and generates, as output, a corresponding output result corresponding to a probability distribution over possible speech recognition hypotheses 394 for the corresponding transcribed speech utterance 304 at the corresponding time step.

Notably, the decoder 250 may include a phoneme decoder configured to decode a sequence of phonemes or a word piece decoder configured to decode a sequence of word pieces. The decoder 250 could also include a grapheme decoder configured to decode a sequence of graphemes or other sub-word units. While the decoder 250 may include the RNN-T decoder architecture depicted in FIG. 2, the decoder may also include other types of decoders such as a Connectionist Temporal Classification (CTC) decoder, a Listen-Attend-Spell (LAS) decoder, or a large language model (LLM) decoder.

In some examples, the probability distribution over possible speech recognition hypotheses 394 includes the one of possible phoneme labels, the possible word piece labels, or the possible grapheme labels. Thereafter, a supervised loss module 340 may determine a speech loss term 344 based on the probability distribution over possible speech recognition hypotheses 394 and the corresponding transcription 302 paired with the corresponding training input token sequence 310 characterizing thea speech representation of the corresponding transcribed speech utterance 304. Here, the corresponding transcription 302 serves as a ground-truth transcription and may include a sequence of target phonemes, target word pieces, and/or target graphemes. When the ASR model 200 includes the CTC decoder 250, the speech loss term 344 includes a CTC loss. When the ASR model 200 includes the RNN-T model 200 that includes the RNN-T decoder 250 of FIG. 2, the speech loss term 344 includes an RNN-T loss. The training process 300 trains the model 200 based on the supervised speech loss terms 344 by updating parameters of the audio encoder 210 and/or the decoder 250 using the supervised speech loss terms 344.

FIG. 4 shows a schematic view 400 of the model 200 performing speech recognition on the utterance 106 spoken by the user 104 and captured by the audio capture device 16a of FIG. 1 after the model 200 is trained by the training process 300 of FIG. 3. The audio subsystem 108 is configured to receive the utterance 106 spoken by the user 104 and captured by the audio capture device 16a, and convert the utterance 106 into a corresponding digital format associated with the input speech tokens 110. In the example shown, the user speaks a respective utterance 106 and the audio subsystem 108 converts the utterance 106 into a sequence of speech tokens 110, 110a-n for input to the ASR model 200. Next, the contemplation mechanism 80 inserts a sequence of special think tokens 112 into the sequence of speech tokens 110 such that the special think tokens 112 are interleaved with the sequence of speech tokens 110. For each corresponding speech token 110, the contemplation mechanism 80 may insert the special think tokens 112 by appending or prepending a fixed number of the special think tokens 112 to the corresponding speech token 110. In the example shown, the contemplation mechanism 80 prepends one think tokens 112 to each speech token 110. Notably, the contemplation mechanism 80 may prepend two or more think tokens 112 to each speech token 110, or instead, the contemplation mechanism 80 may append one or more think tokens 312 to each speech input token 310 without departing from the scope of the present disclosure.

Appending think tokens 112 allows for processing by the encoder 210 to rely on hidden vectors generated for the corresponding speech token. Conversely, prepending think tokens 112 offers the encoder 210 visibility into additional computational outcomes before directly processing the corresponding speech token 110, which may provide a potentially beneficial relationship. As the audio encoder 210 may include limited left and right context windows, the left and right context windows may be increased proportionally to the number of think tokens 110 is appending or prepending to each corresponding speech token 110. By increasing the left and right context windows proportional to the number of think tokens 110, parity may be maintained in terms of the original speech tokens 110 visible to the audio encoder 210.

With continued reference to FIG. 4, the audio encoder 210 processes the sequence of speech tokens 110 interleaved with the special think tokens 112 to generate a sequence of encoder features h 212. The audio encoder 210 may generate each encoder feature 210 from a respective speech token 110 or think token 112 at each corresponding time step Notably, a number of the encoder features 210 is equal to a sum of a number of the speech tokens 110a-n in the corresponding sequence of speech tokens 110 and a number of the think tokens 112 in the sequence of special tokens 312. Thus, as the number of encoder features 210 is greater than the number of speech tokens 112 in the sequence of speech tokens 110 characterizing the spoken utterance 106, a down sample mechanism 85 may down-sample the sequence of encoder features h 212 output by the encoder 210 to obtain a down-sampled encoder feature sequence 212D. Here, the down-sampled encoder feature sequence 212D includes a number of encoder features 212 that is equal to the number of speech tokens 110 in the sequence of speech tokens 110. Thereafter, the decoder 250 processes the down-sampled encoder feature sequence 212D to generate an output result 194. Specifically, the decoder 250 receives, as input, each encoder feature 212 from the down-sampled encoder feature sequence 212D and generates, as output, a corresponding output result 194 corresponding to a probability distribution over possible speech recognition hypotheses for the spoken utterance 106 at the corresponding time step. Ultimately, the probability distributions over possible speech recognition hypotheses generated by processing all of the down-sampled encoder features 212D form a transcription 120 of the utterance 106. For instance, a beam search may select the transcription 120 from a lattice of candidate transcriptions based on the probability distributions over possible speech recognition hypotheses. Notably, the decoder 250 may include a phoneme decoder configured to decode a sequence of phonemes or a word piece decoder configured to decode a sequence of word pieces. The decoder 250 could also include a grapheme decoder configured to decode a sequence of graphemes or other sub-word units. While the decoder 250 may include the RNN-T decoder architecture depicted in FIG. 2, the decoder may also include other types of decoders such as a Connectionist Temporal Classification (CTC) decoder, a Listen-Attend-Spell (LAS) decoder, or a large language model (LLM) decoder. Notably, contemplation mechanism 80 may insert the special think tokens 112 as the speech tokens 110 are received from the audio subsystem 108 in a streaming fashion to support a streaming speech encoder 210. The speech encoder 210 may also operate in a non-streaming mode by processing the speech tokens 110 interleaved with the special think tokens 112. Accordingly, the contemplation mechanism 80 for interleaving the special think tokens 112 can be applied equivalently by both causal (streaming) encoders and non-causal (non-streaming) encoders.

The down-sampling performed by the down sample mechanism 85 may be optional. When down sampling is not performed on the original encoder features 210 output from the encoder 210, the decoder 250 simply processes the longer sequence of encoder features 210 which may amplify benefits of enhanced feature representation.

While the model 200 of FIGS. 2-4 is depicted as an ASR model, the model 200 may include other types of speech models without departing from the scope of the present disclosure. For instance, the model 200 may instead include a speech translation model that includes a decoder configured to process the down-sampled encoder features 212D to generate a translation of the utterance 106 in a different language than a language of the utterance 106 spoken by the user 104. In another example, the model 200 may include a speech to speech model that includes a decoder configured to process the down-sampled encoder features 212D to generate a synthesized speech representation of the utterance 106 in a different voice than a voice of the user 105 that spoke the utterance 106 and/or in a different language than a language of the utterance 106 of the utterance 106 spoken by the user 104. In other examples, the model 200 may include a keyword detection model where a decoder processes the down-sampled encoder features 212D to determine whether a keyword is present in the utterance 106. In even further examples, the model 200 may include a speaker identification model where the down-sampled encoder features 212 are processed to determine a speaker vector characterizing a voice of the user 104 that spoke the utterance 106. Other speech applications include speech classification models that determine a single prediction per speech sequence such as emotion recognition, language identification, speaker classification, demographic classification, speaker diarization, speaker change detection, disfluency annotation, and speaker state classification to name a few. The present disclosure is not limited to speech, whereby the technique of interleaving a sequence of input tokens (e.g., text tokens, image tokens, etc.) with think tokens can be utilized for other applications such as text-to-text applications or image recognition.

In some implementations, the think tokens 112, 312 inserted by the contemplation mechanism 80 during inference (FIGS. 1 and 4) and training (FIG. 3) are handcrafted think tokens Handcrafted tokens may include think tokens that are predetermined by a user/developer such as zero-tensor think tokens, a mean-feature value of the speech tokens, a fixed value learned from an external model and repeated for each think token 112, a position-derived embedding, or any combination.

In some additional implementations, the think tokens 112, 312 include duplications of the input tokens 110, 310. Here, the input tokens 110, 310 characterizing input speech representations are repeated for k frames where k is equal to the number of think tokens 112, 312. Thus, an input token sequence of A-B-C would be presented as input to the encoder 21 as AAA-BBB-CCC if k is equal to two (2).

In other implementations, the think tokens 112, 312 include learned parameters. Here, the think tokens 112, 312 are treated as a trainable variable to be shared across all think tokens, but optimized along with the objective function of the encoder 210. In these implementations, a standard variable initialization (e.g., structured random initialization) may be applied to obtain initial variables for the think tokens and then updating is applied across all presentations of each think token. As an alternative to updating the variables directly, the think tokens include a fixed initial variable and an adapter may update the fixed initial variable. The adapter could include a residual adapter, low-rank adaptation (LoRA), or residual bottleneck. In other examples, a large language model (LLM) is leveraged to predict the values for the learned parameters representing the think tokens 112, 312.

In some implementations, the presentation of think tokens 110, 310 are alternatively modified by a positional embedding. The position embedding may be additive or concatenated to the think tokens 110, 310. The positional embedding can follow the original sequence length and can be extended as the original sequence (e.g., 1, 1, 1, 2, 2, 2, 3, 3, 3) or applied to the resulting extended sequence (e.g., 1, 2, 3, 4, 5, 6, 7, 8, 9).

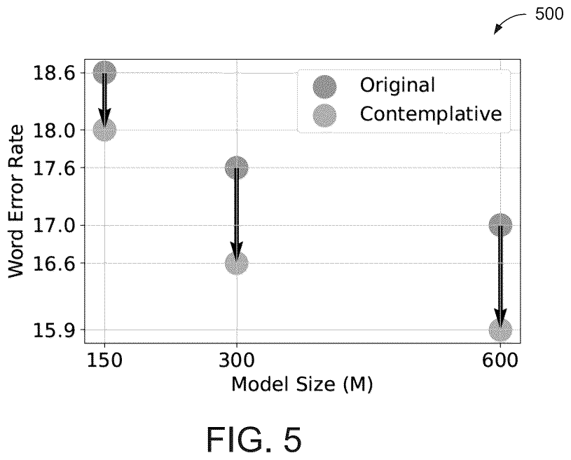

FIG. 5 shows an example plot 500 evaluating speech recognition performance of three ASR models without (Original) implementing the contemplative mechanism 80 with implementing (Contemplative) the contemplative mechanism 80. The x-axis denotes model size in millions (M) and the y-axis denotes word error rate (WER) The three ASR models implement the audio encoder 210 having 24 Conformer layers with varying sizes of 150 million (M) parameters, 300 million (M) parameters, and 600 million (M) parameters, and the RNN-T decoder 250 of FIG. 2. For the ASR models implementing the contemplative mechanism 80, the contemplative mechanism 80 prepends a single learned parameter think token to each original speech token. Additionally, the context window is doubled and the encoder features 212 output by the encoder are down-sampled to accommodate the expanded sequence length. Notably, the insertion of the single think token per each speech token yields a consistent WER reduction across all three model sizes, thereby enabling smaller models to achieve accuracy levels comparable to those of models twice their size. For instance, the WER of the 150M parameter model utilizing the contemplative mechanism 80 closely matches the WER of the 300M parameter model not utilizing the contemplative mechanism 80. Moreover, the WER of the 300M parameter model utilizing the contemplative mechanism 80 outperforms the 600M model not implementing the contemplative mechanism 80.

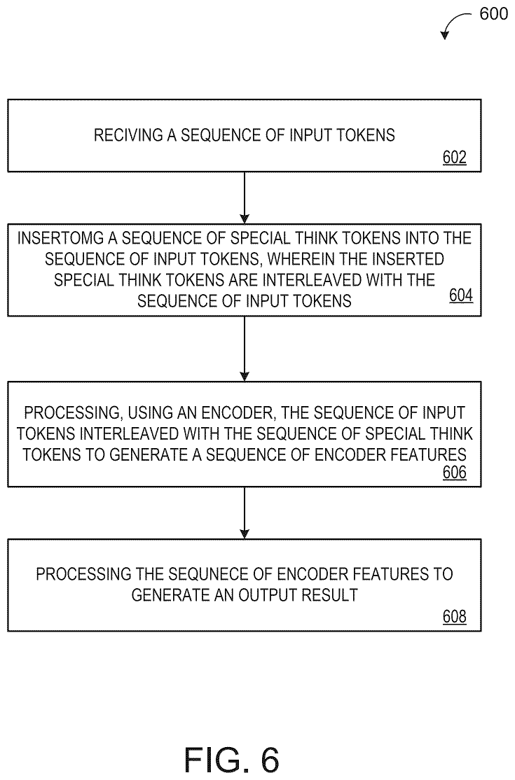

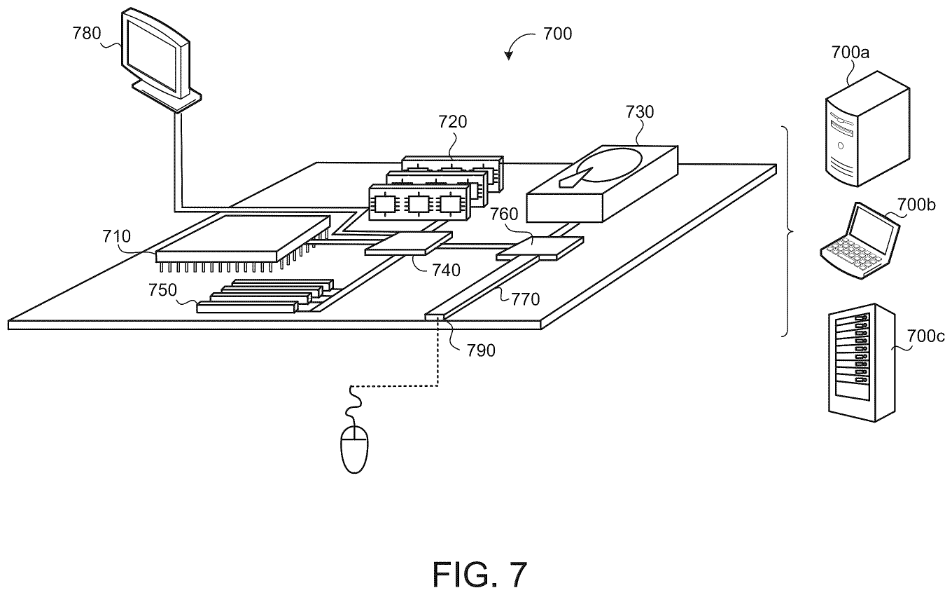

FIG. 6 is a flowchart of an exemplary arrangement of operations for a method 600 of increasing computation per speech token within an encoder while maintaining an original parameter count of the encoder. The method 600 may execute on data processing hardware 710 (FIG. 7) based on instructions stored on memory hardware 720 (FIG. 7). The data processing hardware 710 may include the data processing hardware 62 of the remote computing system 60 or the data processing hardware 12 of the user device 10. The memory hardware 720 may include the memory hardware 64 of the remote computing system 60 or the memory hardware 14 of the user device 10.

At operation 602, the method 600 includes receiving a sequence of input tokens 110. The input tokens may include speech tokens characterizing a sequence of acoustic frames characterizing a spoken utterance 106. At operation 604, the method 600 includes inserting a sequence of special think tokens 112 into the sequence of input tokens 110. The inserted special think tokens 112 are interleaved with the sequence of input tokens 110. For instance, a fixed number of special think tokens 112 may be appended or prepended to each corresponding input token 110 in the sequence of input tokens 110.

At operation 606, the method 600 includes processing, using an encoder 210, the sequence of input tokens 110 interleaved with the sequence of special think tokens 112 to generate a sequence of encoder features 212. At operation 608, the method includes processing the sequence of encoder features 210 to generate an output result. The output result may include a transcription of the spoken utterance. The output result could also include a synthetic speech translation of the spoken utterance.

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving a sequence of input tokens;
inserting a sequence of special think tokens into the sequence of input tokens, wherein the inserted special think tokens are interleaved with the sequence of input tokens;
processing, using an encoder, the sequence of input tokens interleaved with the sequence of special think tokens to generate a sequence of encoder features; and
processing the sequence of encoder features to generate an output result.

2. The computer-implemented method of claim 1, wherein inserting the sequence of special tokens comprises, for each corresponding input token in the sequence of input tokens, prepending a fixed number of the special think tokens to the corresponding input token.

3. The computer-implemented method of claim 1, wherein inserting the sequence of special tokens comprises, for each corresponding input token in the sequence of input tokens, prepending a fixed number of the special think tokens to the corresponding input token.

4. The computer-implemented method of claim 1, wherein the sequence of input tokens comprises a sequence of speech tokens characterizing a spoken utterance and the encoder comprises a speech encoder.

5. The computer-implemented method of claim 4, wherein the output result comprises a transcription of the spoken utterance.

6. The computer-implemented method of claim 4, wherein the output result comprises a synthetic speech translation of the spoken utterance.

7. The computer-implemented method of claim 1, wherein the special think tokens comprise handcrafted think tokens.

8. The computer-implemented method of claim 1, wherein:
the sequence of special think tokens comprise duplications of the sequence of input tokens; and
inserting the sequence of special tokens comprises, for each corresponding input token in the sequence of input tokens:
duplicating the corresponding input token; and
appending or prepending one or more duplications of the corresponding input token to the corresponding input token.

9. The computer-implemented method of claim 1, wherein the special think tokens comprise learnable parameters.

10. The computer-implemented method of claim 1, wherein:
a number of the encoder features in the sequence of encoder features is equal to a sum of a number of the input tokens in the sequence of input tokens and a number of the special think tokens in the sequence of special think tokens; and
processing the sequence of encoder features to generate the output result comprises:
down-sampling the sequence of encoder features to obtain a down-sampled encoder feature sequence, wherein a number of the encoder features in the down-sampled encoder feature sequence is equal to the number of the input tokens in the sequence of input tokens; and
processing, using a decoder, the down-sampled encoder feature sequence to generate the output result.

11. The computer-implemented method of claim 1, wherein processing the sequence of encoder features to generate the output result comprises processing, using a decoder, the sequence of encoder features to generate the output result.

12. The computer-implemented method of claim 11, wherein a number of the encoder features in the sequence of encoder features is greater than a number of the input tokens in the sequence of input tokens.

13. The computer-implemented method of claim 1, wherein a model implementing the encoder is trained by a training process that comprises:
obtaining a set of set of training input token sequences, each training input token sequence comprising a corresponding sequence of training input tokens
for each training input token sequence:
inserting a corresponding sequence of training think tokens into the training input token sequence such that corresponding sequence of training think tokens are interleaved with the corresponding sequence of training input tokens; and
processing, using the encoder, the training input token sequence interleaved with the corresponding sequence of training think tokens to generate a sequence of training encoder features; and
training the model based on the sequence of training encoder features generated for each training input token sequence.

14. The computer-implemented method of claim 13, wherein a ratio of the corresponding sequence of training think tokens inserted into each training input token sequence gradually increases during the training process.

15. The computer-implemented method of claim 13, wherein the model comprises a recurrent neural network-transducer (RNN-T) architecture comprising the encoder, a prediction network, and a joint network.

16. A system comprising:
data processing hardware; and
memory hardware in communication with the data processing hardware and storing instructions that when executed on the data processing hardware cause the data processing hardware to perform operations comprising:
receiving a sequence of input tokens;
inserting a sequence of special think tokens into the sequence of input tokens, wherein the inserted special think tokens are interleaved with the sequence of input tokens;
processing, using an encoder, the sequence of input tokens interleaved with the sequence of special think tokens to generate a sequence of encoder features; and
processing the sequence of encoder features to generate an output result.

17. The system of claim 16, wherein inserting the sequence of special tokens comprises, for each corresponding input token in the sequence of input tokens, prepending a fixed number of the special think tokens to the corresponding input token.

18. The system of claim 16, wherein inserting the sequence of special tokens comprises, for each corresponding input token in the sequence of input tokens, prepending a fixed number of the special think tokens to the corresponding input token.

19. The system of claim 16, wherein the sequence of input tokens comprises a sequence of speech tokens characterizing a spoken utterance and the encoder comprises a speech encoder.

20. The system of claim 19, wherein the output result comprises a transcription of the spoken utterance.

21. The system of claim 19, wherein the output result comprises a synthetic speech translation of the spoken utterance.

22. The system of claim 16, wherein the special think tokens comprise handcrafted think tokens.

23. The system of claim 16, wherein:
the sequence of special think tokens comprise duplications of the sequence of input tokens; and
inserting the sequence of special tokens comprises, for each corresponding input token in the sequence of input tokens:
duplicating the corresponding input token; and
appending or prepending one or more duplications of the corresponding input token to the corresponding input token.

24. The system of claim 16, wherein the special think tokens comprise learnable parameters.

25. The system of claim 16, wherein:
a number of the encoder features in the sequence of encoder features is equal to a sum of a number of the input tokens in the sequence of input tokens and a number of the special think tokens in the sequence of special think tokens; and
processing the sequence of encoder features to generate the output result comprises:
down-sampling the sequence of encoder features to obtain a down-sampled encoder feature sequence, wherein a number of the encoder features in the down-sampled encoder feature sequence is equal to the number of the input tokens in the sequence of input tokens; and
processing, using a decoder, the down-sampled encoder feature sequence to generate the output result.

26. The system of claim 16, wherein processing the sequence of encoder features to generate the output result comprises processing, using a decoder, the sequence of encoder features to generate the output result.

27. The system of claim 26, wherein a number of the encoder features in the sequence of encoder features is greater than a number of the input tokens in the sequence of input tokens.

28. The system of claim 16, wherein a model implementing the encoder is trained by a training process that comprises:
obtaining a set of set of training input token sequences, each training input token sequence comprising a corresponding sequence of training input tokens
for each training input token sequence:
inserting a corresponding sequence of training think tokens into the training input token sequence such that corresponding sequence of training think tokens are interleaved with the corresponding sequence of training input tokens, and
processing, using the encoder, the training input token sequence interleaved with the corresponding sequence of training think tokens to generate a sequence of training encoder features; and
training the model based on the sequence of training encoder features generated for each training input token sequence.

29. The system of claim 28, wherein a ratio of the corresponding sequence of training think tokens inserted into each training input token sequence gradually increases during the training process.

30. The system of claim 28, wherein the model comprises a recurrent neural network-transducer (RNN-T) architecture comprising the encoder, a prediction network, and a joint network.
